(19) United States
(12) Patent Application Publication
(10) Pub. No.: US 2019/0232643 A1
(43) Pub. Date: Aug. 1, 2019

(54) PRINTING APPARATUS, PRINTING METHOD, AND DECORATIVE MEMBER SUPPORT

(71) Applicant: MIMAKI ENGINEERING CO., LTD., Nagano (JP)

(72) Inventors: Yasunori Yamazaki, Nagano (JP); Nobuo Kanai, Nagano (JP)

(73) Assignee: MIMAKI ENGINEERING CO., LTD., Nagano (JP)

(21) Appl. No.: 16/330,100

(22) PCT Filed: Sep. 8, 2017
(86) PCT No.: PCT/JP2017/032538

§ 371 Date: Mar. 4, 2019

(30) Foreign Application Priority Data
Sep. 16, 2016 (JP) 2016-181601

(51) Int. Cl. B41J 2/045; B41J 3/407

(52) U.S. Cl. CPC B41J 2/04536; B41J 2/04586; B41J 3/4078

(57) ABSTRACT

A printing apparatus includes an image formation device and a control device. The image formation device ejects an ink for image formation to a fabric to form an image on the fabric. The control device generates, based on a first image data of an original image to be formed on the fabric, a second image data of a mark-applied image which is the original image additionally including a mark at a target position of a decorative member to be attached to the fabric. Then, the control device controls the image formation device based on the second image data so as to form the mark-applied image on the fabric.

### TECHNICAL FIELD

This invention relates to a printing apparatus, a printing method, and a decorative member support.

### BACKGROUND ART

There are known fabrics attached with decorative members such as spangles or beads. Such a member for decoration may be selected from suitable ones for a pattern printed on a fabric to be decorated and then attached to the fabric. Among the known printing apparatuses used to print objects on mediums such as fabrics are inkjet printers with heads from which ink is ejected to the mediums (for example, see Patent Literature 1). It has been proposed to use such inkjet printers to print patterns on fabrics to be attached with decorative members.

### CITATION LIST

### Patent Literature

Patent Literature 1: Japanese Unexamined Patent Publication No. 2015-13455

### SUMMARY OF INVENTION

### Technical Problems

When a decorative member is attached to a fabric, conventionally, an operator, while comparing a pattern printed on the fabric with a design drawing showing a position at which the decorative member should be attached, may decide a target position of the decorative member on the fabric in accordance with the position on the design drawing. This is a manual work performed by the operator, in which the target position finally decided may possibly differ in accuracy depending on the operator's level of expertise. As a result, the decorative member may be attached to different positions from one fabric to another.

This invention has been accomplished to address the issue of the known art and is directed to providing a printing apparatus, a printing method, and a decorative member support that may suppress positional variability of a decorative member when attached to a fabric after an image or a pattern is printed on the fabric.

### Solutions to Problems

A printing apparatus according to this invention includes an image formation device and a control device. The image formation device is configured to eject an ink for image formation to a fabric to form an image on the fabric. The control device is configured to generate, based on a first image data of an original image to be formed on the fabric, a second image data of a mark-applied image which is the original image additionally including a mark at a target position of a decorative member to be attached to the fabric. Then, the control device is configured to control the image formation device based on the second image data so as to form the mark-applied image on the fabric.

According to this invention, the mark-applied image is formed that additionally includes a mark at a target position of the decorative member. This may facilitate a process to decide the target position of the decorative member on the fabric. When the decorative member is attached to the image-printed fabric, therefore, positioning of the decorative member may be less variable.

In an embodiment of the printing apparatus, when a target region of the decorative member is defined in at least part of the original image, the control device may be configured to decide, as the target position, a position in the target region meeting a predetermined condition.

According to this invention, when a target region of the decorative member is defined in at least part of the original image, a position in the target region meeting a predetermined condition is decided as the target position. In the case of a large number of decorative members to be handled, the operator may save the trouble of deciding an accordingly large number of target positions.

The predetermined condition may include at least one of a shape, a size, a quantity, a pitch, and a pattern of the mark to be applied to the target position.

According to the invention, a position suitable for at least one of the shape, size, quantity, pitch, and pattern of the mark to be applied to the target position is decided as the target position. Thus, the target position may be more appropriately decided and set.

The control device may be configured to set the mark to be displayed in a color that differs from a color used in a part surrounding the target position in the original image.

According to this invention that forms the mark in any color but colors of parts surrounding the target position in the original image, the mark may be more distinctly distinguishable.

The printing apparatus may further include a display device configured to be capable of displaying the mark-applied image.

According to this invention, the mark-applied image may be displayed on the display device as a preview image and checked by the operator beforehand.

The printing apparatus may further include an operation device configured to be capable of changing the target position in the original image.

This may allow the operator to change the target position after he/she checked the mark-applied image displayed on the display device.

A printing method according to this invention is for being utilized in a printing apparatus including an image formation device that ejects an ink for image formation to a fabric to form an image on the fabric. The printing method includes: a generating step of generating, based on a first image data of an original image to be formed on the fabric, a second image data of a mark-applied image which is the original image additionally including a mark at a target position of a decorative member to be attached to the fabric; and an image forming step of forming the mark-applied image on the fabric based on the second image data using the image formation device.

According to this invention, the mark-applied image is formed that additionally includes a mark at a target position of the decorative member. This may facilitate a process to decide the target position of the decorative member on the fabric. When the decorative member is attached to the image-printed fabric, therefore, positioning of the decorative member may be less variable.

Means for attaching the decorative member to the fabric may include but is not limited to sewing. For example, this invention may provide a decorative member support that supports a decorative member attached to the fabric. The decorative member support may include: a base, having an adherable part adherable to the fabric; and a supporter, integral with the base and serving to support the decorative member.

According to this invention, the decorative member is supported by the supporter after the adherable part of the base is attached to the fabric in order to attach the decorative member to the fabric. In this manner, directly sewing the decorative member into the fabric may be unnecessary. As a result, the decorative member may be readily attached to the fabric. A mark may be applied to a position on the fabric at which the base will be attached. The attachment position of the base on the fabric may be accordingly more easily identified. Thus, positioning of the base, eventually, positioning of the decorative member, may be less variable. The operation to adhere the base to the fabric may be automated by using a device, for example, robot. In this instance, a mark may be applied to the attachment position of the base on the fabric to allow the mark image and position to be recognized and measured by a device, such as robot. The attachment position of the base may be accordingly detected with higher reliability

The decorative member may have an annular shape, and the supporter may oscillatably support the decorative member.

According to this invention providing the structure in which the supporter oscillatably supports the annular decorative member, the decorative member may be allowed to oscillate as if it were sewn into the fabric.

The supporter may include a first surface supporter, a second surface supporter, and an inner surface supporter characterized as described below. The first surface supporter supports a first surface of the decorative member on a side thereof closer to the fabric. The second surface supporter supports a second surface of the decorative member on a side thereof opposite to the fabric. The inner surface supporter supports an inner surface of the decorative member. The first surface supporter and the second surface supporter have diameters greater than an inner diameter of the decorative member. The inner surface supporter has a diameter smaller than the inner diameter of the decorative member. The first surface supporter and the second surface supporter are spaced apart with a distance greater than a thickness of the decorative member.

According to this invention, the first and second surface supporters having diameters greater than the inner diameter of the decorative member may be allowed to support the decorative member, with its first and second surfaces being held between these supporters. This may prevent the decorative member from falling off. Further, the inner surface supporter having a diameter smaller than the inner diameter of the decorative member supports the inner surface of the decorative member, and the first and second surface supporters are spaced apart with a distance greater than the thickness of the decorative member. These structural features provide spaces between the first surface and the first surface supporter, between the second surface and the second surface supporter, and between the inner surface and the inner surface supporter. In the presence of such spaces, the decorative member may be supported, with some room to oscillate, by the first surface supporter, second surface supporter, and inner surface supporter. The supporter including the first surface supporter, second surface supporter, and inner surface supporter, therefore, may reliably support the decorative member allowed to oscillate.

### Effects of the Invention

The printing apparatus, printing method, and decorative member support according to this invention thus characterized may suppress positional variability of a decorative member when attached to a fabric after an image or a pattern is printed on the fabric. According to the decorative member support provided by this invention, the decorative member may be attached to the fabric without sewing. In the decorative member support according to this invention, an adherable part of its base may be more efficiently attached to the fabric in an automated manner.

### BRIEF DESCRIPTION OF DRAWINGS

FIG. 1 is a drawing that illustrates a printing apparatus according to an embodiment of this invention.

FIG. 2 is a block diagram that illustrates a control device.

FIG. 3 is a flow chart of an exemplified operation to form a mark-applied image on a fabric.

FIG. 4 is a drawing of an original image based on first image data inputted to the control device.

FIG. 5 is a drawing of the original image on which target positions have been decided and set in a target region.

FIG. 6 is a drawing of an example of the mark-applied image displayed on a display device.

FIG. 7 is a drawing of an example of the mark-applied image displayed on the display device after the target positions are partly changed.

FIG. 8 is a sectional view of an example of the decorative member support according to the embodiment.

FIG. 9 is a plan view of an example of the decorative member support.

FIG. 10 is a drawing that illustrates a step of manufacturing the decorative member support.

FIG. 11 is a drawing that illustrates a step of manufacturing the decorative member support.

FIG. 12 is a drawing that illustrates a decorative member support according to a modified embodiment of this invention.

FIG. 13 is a drawing that illustrates a decorative member support according to a modified embodiment of this invention.

FIG. 14 is a drawing that illustrates of an example of the decorative member fitting system according to a modified embodiment of this invention.

FIG. 15 is a drawing that illustrates an exemplified operation of the decorative member fitting system.

FIG. 16 is a drawing that illustrates another exemplified operation of the decorative member fitting system.

FIG. 17 is a drawing that illustrates examples of arrangement of target positions.

FIG. 18 is a drawing that illustrates another example in which target positions are decided and set by a target position setting unit.

### DESCRIPTION OF EMBODIMENTS

Embodiments of a printing apparatus, a printing method, and a decorative member support are hereinafter described referring to the accompanying drawings. It should be understood, however, that this invention includes but is not limited to the embodiments. Structural and technical features according to the embodiments below include ones easily replaceable or achievable by those skilled in the art or substantially identical ones.

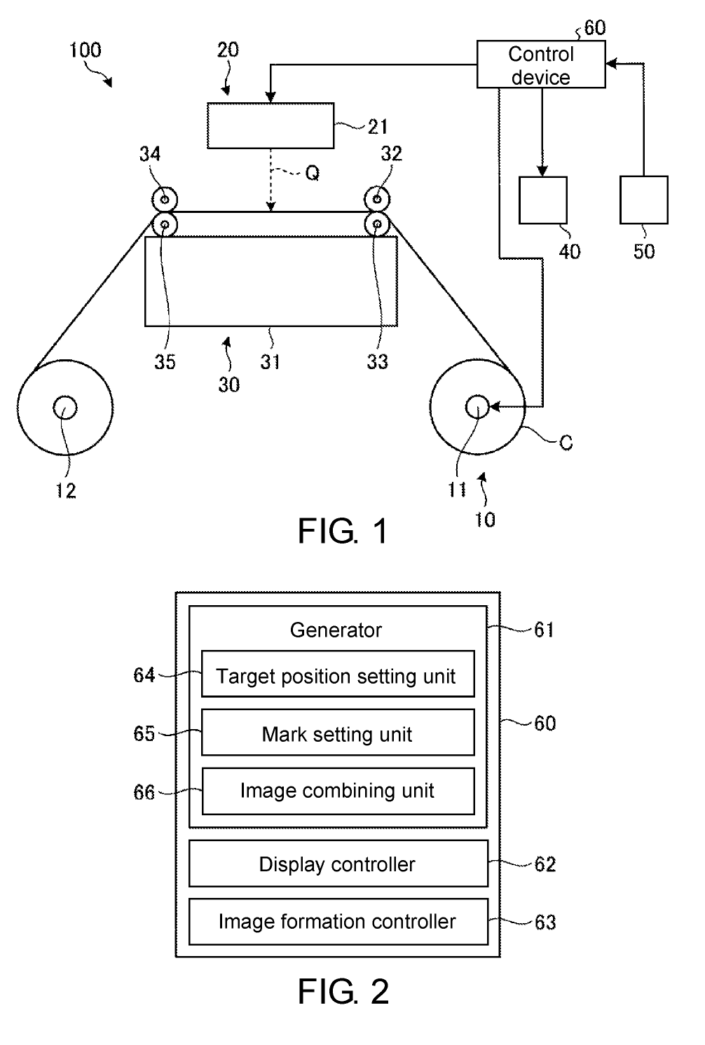

FIG. 1 is a drawing that illustrates a printing apparatus 100 according to an embodiment of this invention. As illustrated in FIG. 1, the printing apparatus 100 is a printer configured to print an image such as a character and a diagram on a recording surface (surface to be printed) of a fabric C. In this embodiment, the fabric C may be wound up in a roll, however, is not necessarily limited to such a form.

The printing apparatus 100 includes a fabric transporter 10, an image formation device 20, a fabric supporter 30, a display device 40, an operation device 50, and a control device 60. The fabric transporter 10 transports the rolled fabric C. The fabric transporter 10 includes a feeder 11 and a winder 12. The feeder 11 unwinds and feeds the rolled fabric C. The winder 12 rewinds the fabric C into a roll.

The image formation device 20 ejects ink Q for image formation onto the recording surface of the fabric C to form an image on the fabric C. The image formation device 20 has an ejection head 21 from which the ink Q is ejected. The ejection head 21 may be held in a carriage not illustrated in the drawing. The ejection head 21 is allowed to reciprocate in a scanning direction intersecting with a direction in which the fabric C is transported. The ejection head 21 ejects, through nozzles not illustrated in the drawing, the ink Q for image formation onto the fabric C. The nozzles of the ejection head 21 may be arranged in the transport direction of the fabric C. The ejection head 21, however, may be structured and configured otherwise.

The fabric supporter 30 supports the fabric C in the transport path of the fabric C. The fabric supporter 30 includes an ink receiver 31, a feed roller 32, a tension roller 34, and pinch rollers 33 and 35. The ink receiver 31 is disposed at a position below the ejection head 21. In case the fabric C has a rough texture, the ink Q ejected from the ejection head 21 may partly fail to stay on the recording surface of the fabric C, passing through the fabric C and dropping downward. This event may be conventionally called bleed-through. The ink Q thus bleeding through the fabric C is received by and retained in the ink receiver 31 disposed below the ejection head 21.

The feed roller 32 supports the fabric C. The pinch roller 33 is disposed more upward than the feed roller 32 and stays in elastic contact with the feed roller 32. The feed roller 32 and the pinch roller 33 feed the fabric C, holding the fabric C from vertically upper and lower sides. The tension roller 34 confers a tension that acts in a certain feed direction to the fabric C. The pinch roller 35 is disposed more upward than the tension roller 34 and stays in elastic contact with the tension roller 34. The pinch roller 35 may be a dispensable component.

The display device 40 displays various pieces of information including characters and images. The display device 40 is equipped with a display panel, for example, a liquid crystal panel. The display device 40 is allowed to display image-related information including images based on image data inputted from an external apparatus and images to be formed on the fabric C by the image formation device 20, and information regarding operations carried out by the printing apparatus 100.

The operation device 50 outputs command signals to the control device 60. An example of the operation device 50 is an input device such as a touch panel. Other examples of the operation device 50 include buttons, levers, dials, and switches, which may be used other than or in addition to the touch panel. The operation device 50 outputs, to the control device 60, command signals according to predetermined input operations.

This embodiment describes an example in which the touch panel used as the operation device 50 is superimposed on the display panel of the display device 40. In this example, images to be touched for operation on the touch panel are displayable on the display device 40. When an operator touches a region including an image for operation displayed on the touch panel, the operation device 50 outputs a predetermined command signal to the control device 60. The display device 40 and the operation device 50, however, may be structured and configured otherwise.

The control device 60 is in charge of overall operation control of the fabric transporter 10, image formation device 20, fabric supporter 30, display device 40, and operation device 50. FIG. 2 is a block diagram that illustrates an example of the control device 60. As illustrated in FIG. 2, the control device 60 includes a generator 61, a display controller 62, and an image formation controller 63.

The control device 60 has an input unit used to input image from outside, and a storage in which various pieces of data are storable. The image data inputted through the input unit includes, for example, first image data of an original image to be formed on the fabric C. The data stored in the storage includes data associated with a decorative member to be attached to the fabric C, for example, shape, size, color, and type of the decorative member, and mark image data of a mark(s) to be applied to a target position of the decorative member on the fabric C. Examples of the decorative member include spangles or beads.

The generator 61 generates, based on the first image data of the original image to be formed on the fabric C, second image data of a mark-applied image which is the original image additionally including a mark(s) at the target position of the decorative member on the fabric C. The generator 61 has a target position setting unit 64, a mark setting unit 65, and an image combining unit 66.

When a target region of the decorative member is defined in at least part of the original image, the target position setting unit 64 decides, as the target position, a position in the target region meeting a predetermined condition. The predetermined condition may include at least one of a shape, size, quantity, pitch, and pattern of the mark applied to the target position.

The mark setting unit 65 configures the mark to be displayed in a color that differs from a color used in a part surrounding the target position in the original image. The mark setting unit 65 selects an appropriate one of different marks from the mark image data stored in the storage based on the decorative member-related data, for example, the shape, size, color, and type of the decorative member.

The image combining unit 66 combines the mark with the original image to generate the second image data of the mark-applied image. The display controller 62 selects information to be displayed on the display device 40 and controls a timing of displaying the selected information. The image formation controller 63 controls the operation of the image formation device 20 based on the first or second image data so as to form an image indicated by the first or second image data on the fabric C.

Next, operations carried out by the printing apparatus 100 thus characterized are hereinafter described. First, the fabric C is set in the printing apparatus 100 before starting to operate. For example, an operator manually sets a roll of fabric C in the feeder 11 and pulls out an end of the rolled fabric C. Then, the fabric C is laid along the transport path and wound around the winder 12. The fabric C is now properly set and ready for printing.

The printing apparatus 100 controls the structural elements using the control device 60 when an operation-start instruction is inputted to the control device 60 after the fabric C is ready to be transported. At the time, the control device 60 receives, as well as the operation-start instruction, the first image data of the original image to be formed on the fabric C. To start with, an operation of the printing apparatus 100 to print the first image data is described.

The image formation controller 63 rotates the feeder 11 and the winder 12 so as to transport the fabric C. Also, the image formation controller 63 prompts the ejection head 21 to eject the ink Q onto the fabric C while reciprocating the ejection head 21 in the scanning direction. The ejected ink Q is adhered to the recording surface (upper surface) of the fabric C. As a result, an image is formed with the ink Q on the recording surface of the fabric C. The ink Q bleeding through the fabric C is received by and retained in the ink receiver 31.

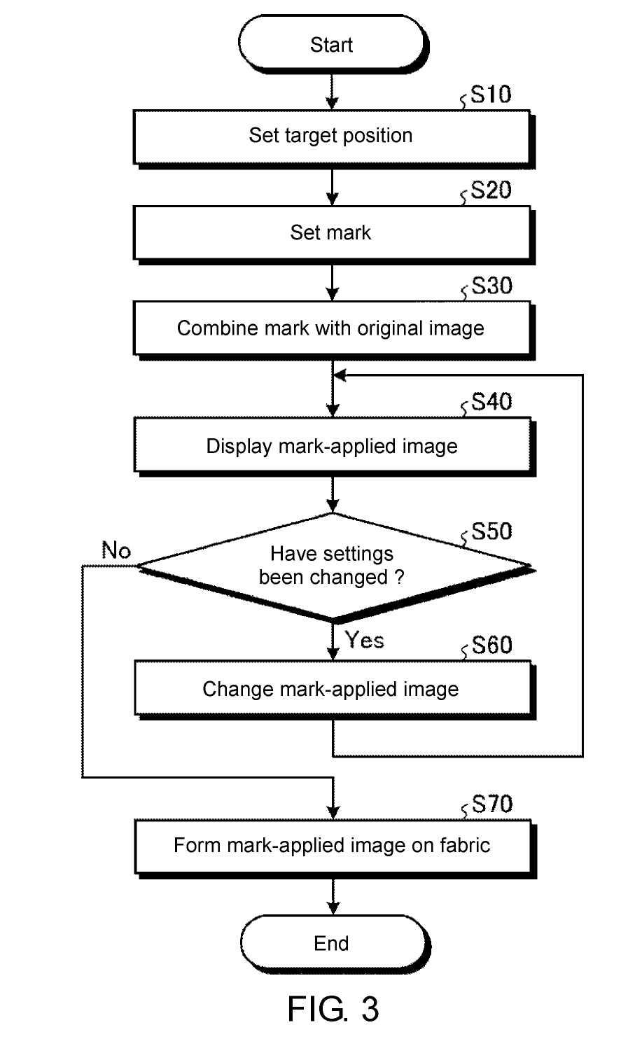

Next, an operation of the printing apparatus 100 to form, on the fabric C, the mark-applied image including a mark at the target position of the decorative member. FIG. 3 is a flow chart of an exemplified operation of the printing apparatus 100 to form the mark-applied image on the fabric C.

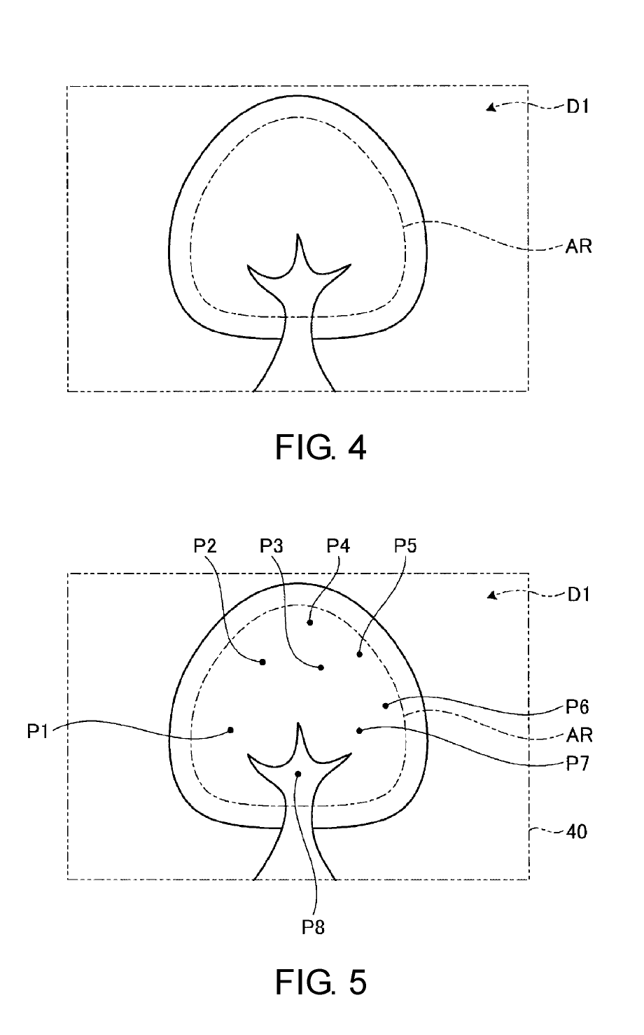

When the operation-start instruction and the first image data are inputted to the control device 60 after the fabric C is set in the printing apparatus, the target position setting unit 64 of the control device 60 decides the target position of the decorative member to be attached in the original image of the first image data, as illustrated in FIG. 3 (Step S10). FIG. 4 is a drawing of an original image D1 according to the first image data inputted to the control device 60. A target region AR of the decorative member is defined in part of the original image D1 illustrated in FIG. 4. The target region AR may be the whole original image D1. FIG. 4 shows a tree trunk and leaves, which is, however, only an example of the original image D1.

The target region AR may be previously defined in the original image D1 inputted to the control device 60 or may be defined and set based on an input operation through the operation device 50. When the target region AR is defined and set based on an input operation through the operation device 50, the display controller 62 may prompt the display device 40 to display thereon the original image D1 to help the operator to set the target region AR using the target position setting unit 64.

When the target region AR is thus set in the original image, the target position setting unit 64 decides, as the target position, a position in the target region AR meeting a predetermined condition. The predetermined condition may include at least one of the shape, size, quantity, and pitch, of the mark applied to the target position. The predetermined condition may be previously decided and inputted to the control device 60 or may be decided and set as prompted by an input operation through the operation device 50. Provided that a preset predetermined condition is used and the target region AR is defined and set, the target position setting unit 64 decides, as the target position, a position in the target region AR meeting the preset predetermined condition. Provided that a predetermined condition inputted through the operation device 50 is used and the target region AR is defined and set, the target position setting unit 64 decides, as the target position, a position in the target region AR meeting the inputted predetermined condition. Thus, the target position is automatically set in the target region AR by the target position setting unit 64. As described later (see FIG. 7), the target position decided and set by the target position setting unit 64 may be manually changed by the operator.

FIG. 5 is a drawing of the original image D1 with target positions already set in the target region AR. In the example illustrated in FIG. 5, there are eight target positions P1 to P8 in the target region AR set by the target position setting unit 64. Among the target positions P1 to P8, P1 to P7 are positions on the tree leaves, and P8 is a position on the tree trunk.

After the setting of the target positions P1 to P8 is completed, the mark setting unit 65 decides what type of marks should be applied to the target positions P1 to P8 (Step S20). In Step S20, the mark setting unit 65 selects, based on the decorative member-related data, an appropriate one of different marks from the mark image data stored in the storage. The mark setting unit 65 configures the marks to be displayed in a color that differs from a color(s) of a part surrounding the target positions P1 to P8 in the original image D1. The mark may be displayed with a preset degree of transparency.

After the marks are applied to the positions, the image combining unit 66 combines the marks with the original image D1 to generate the second image data of the mark-applied image (Step S30). In Step S30, the image combining unit 66 superimposes the marks on the original image D1, with center positions of the marks being located at the target positions P1 to P8 in the original image D1.

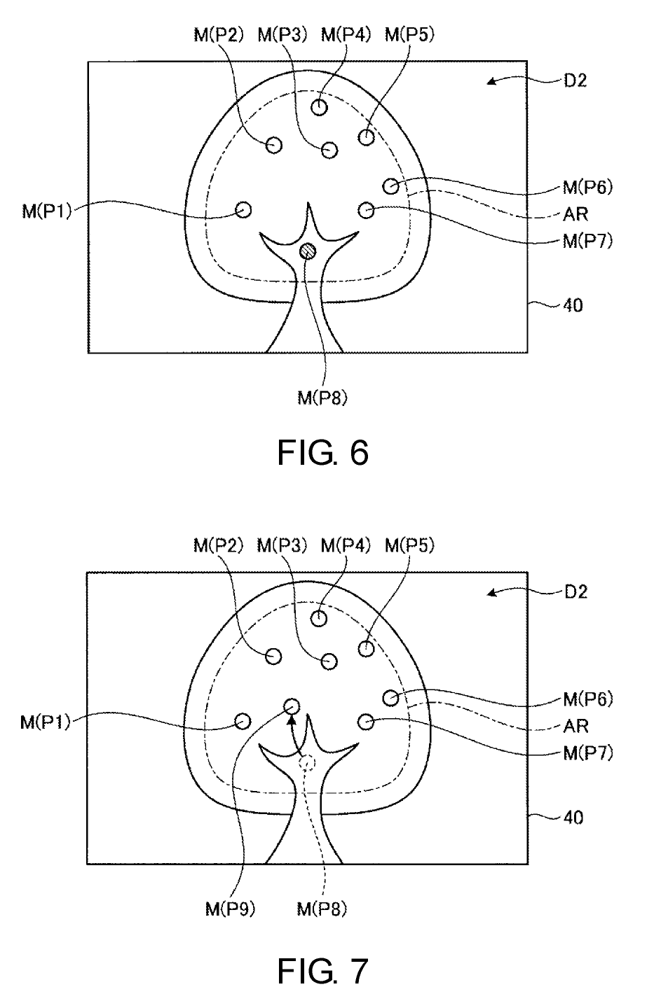

After the mark-applied image is generated, the display controller 62 prompts the display device 40 to display thereon the mark-applied image (Step S40). FIG. 6 is a drawing of an example of the mark-applied image D2 displayed on the display device 40. As illustrated in FIG. 6, the mark-applied image D2 includes marks M at the target positions P1 to P8. In the mark-applied image D2, the marks M at positions on the tree leaves (target positions P1 to P7) are displayed in a color that differs from the color of the mark M at a position on the tree trunk (target position P8). Thus, the marks M may be easily distinguishable in the mark-applied image D2.

After the mark-applied image D2 is displayed, the image combining unit 66 determines whether the operation device 50 has been operated to change settings of the marks M (Step S50). In Step S50, settings of the marks M may be changed by changing their positions, shape, and/or color.

The image combining unit 66 determines that current settings of the marks M have been changed when an operation signal indicating any setting change is inputted through the operation device 50 (Yes in Step S50). In that case, the image combining unit 66 changes, for example, positions of the marks M based on the operation signal and combines the mark-applied image D2 after the change with the original image (Step S60). After the mark-applied image D2 is combined with the original image, the display controller 62 prompts the display device to display thereon the mark-applied image after the change. Then, Step S40 and steps that follow are repeatedly carried out.

FIG. 7 is a drawing of an example of the mark-applied image D2 displayed on the display device 40. FIG. 7 illustrates the mark-applied image D2 after settings of the marks M are changed. FIG. 7 illustrates an example in which the mark M applied at the target position P8 has been moved to a target position P9 on the tree leaves by an operator. In this example, the operator touches and presses the mark M at the target position P8 on the touch panel of the operation device 50 and then slides the pressed mark M to the target position P9. In response to this action, the operation device 50 outputs an operation signal indicating that the position of the mark M has been changed from the target position P8 to the target position P9. Based on the outputted operation signal, the image combining unit 66 deletes the mark M at the target position P8 and applies the mark M to the target position P9. The target position P9 is a position on the tree leaves. The image combining unit 66, therefore, changes the color of the mark M applied at the target position P9 from the color used at the target position P8. Thus, the operator is allowed to manually change the target positions set by the target position setting unit 64.

When an operation signal indicating no change in settings of the marks M is inputted through the operation device 50, the image combining unit 66 determines that the settings remain unchanged (No in Step S50). In this instance, the image formation controller 63 prompts the image formation device 20 to form the mark-applied image D2 on the fabric C (Step S70). In Step S70, the mark-applied image D2 is thus formed on the fabric C. As a result, images of the marks M are formed at positions on the fabric C corresponding to the target positions P1 to P7 and P9.

In the printing apparatus 100 according to this embodiment, the mark-applied image D2 is formed on the fabric C, which additionally includes the marks M at the target positions P1 to P7 and P9 of the decorative member. This may facilitate a process to decide an attachment position(s) of the decorative member to be attached. When the decorative member is attached to the image-printed fabric, therefore, positioning of the decorative member may be less variable.

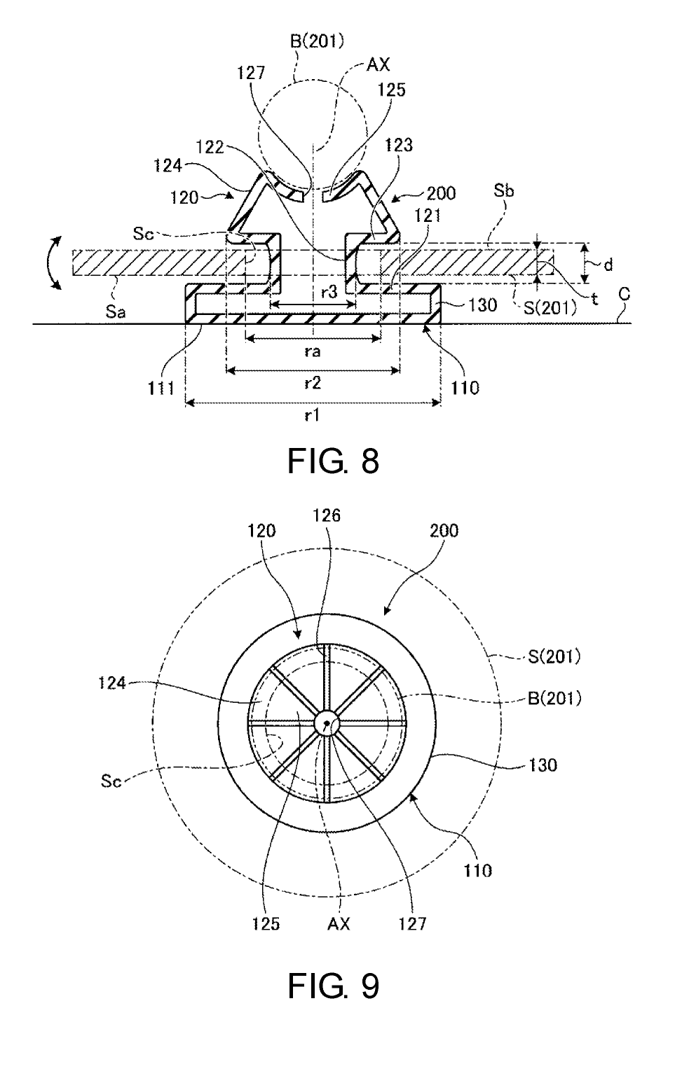

FIG. 8 is a drawing that illustrates a decorative member support 200 according to this embodiment. FIG. 9 is a plan view of the decorative member support 200. The decorative member support 200 illustrated in FIG. 8 and FIG. 9 is used to support a decorative member 201, for example, spangle S or bead B. The decorative member support 200 has a base 110 and a supporter 120. The base 110 and the supporter 120 may be both hollow and integrally formed with a resin material. The decorative member support 200 has a circular shape in a plan view and includes a center axis AX.

The base 110 has a disk-shaped adherable part 111. The adherable part 111 is a part adhered to the fabric C. The adherable part 111 may have, on its bottom surface (lower surface in FIG. 8), an adhesive material, for example, double-sided tape, for bonding to the fabric surface. On the bottom surface of the adherable part 111 may be formed at least one of a protrusion and a dent to facilitate adhesion of the adhesive material.

The supporter 120 is integrally coupled with the base 110 with a coupling 130. The supporter 120 has a first surface supporter 121, an inner surface supporter 122, a second surface supporter 123, a coupling 124, and a bead supporter 125.

The first surface supporter 121 supports a first surface (lower surface in FIG. 8) Sa of the spangle S. The first surface supporter 121 may have an annular shape. An outer peripheral part of the first surface supporter 121 is connected to the coupling 130, while an inner peripheral part of the first surface supporter 121 is connected to the inner surface supporter 122.

The inner surface supporter 122 supports an inner surface Sc of the spangle S. The inner surface supporter 122 may have a tubular shape. One end of the inner surface supporter 122 closer to the base 110 is connected to the first surface supporter 121, while the other end of the inner surface supporter 122 opposite to the base 110 is connected to the second surface supporter 123.

The second surface supporter 123 supports a second surface (upper surface in FIG. 8) Sb of the spangle S. The second surface supporter 123 may have an annular shape. An inner peripheral part of the second surface supporter 123 is connected to the inner surface supporter 122, while an outer peripheral part of the second surface supporter 123 is connected to the coupling 124.

A diameter r1 of the first surface supporter 121 and a diameter r2 of the second surface supporter 123 are greater than an inner diameter ra of the spangle S. This may suppress the risk of the spangle S falling off. A diameter r3 of the inner surface supporter 122 is smaller than the inner diameter ra of the spangle S. The inner surface supporter 122 has a height greater than a thickness t of the spangle S. This means that an interval d between the second surface supporter 123 and the first surface supporter 121 is greater than the thickness t. There are spaces, therefore, between the first surface Sa of the spangle S and the first surface supporter 121, between the second surface Sb of the spangle S and the second surface supporter 123, and between the inner surface Sc of the spangle S and the inner surface supporter 122. In the presence of these spaces, the spangle S may be oscillatably supported by the first surface supporter 121, second surface supporter 122, and inner surface supporter 123.

The second surface supporter 123 and the bead supporter 125 are coupled with the coupling 124. The bead supporter 125 is so shaped that is curved from the outer peripheral side toward the center axis AX along the outer diameter of a bead B. The bead B is fitted in and supported by the bead supporter 125. The bead supporter 125 has a plurality of slits 126 and an opening 127. The bead supporter 125 is divided by the slits 126 into a plurality of parts around the center axis AX. The slits 126 extend from the bead supporter 125 to the coupling 124. The coupling 124, therefore, may also be likely to deform.

When a pressure is acted upon a side of the spangle S closer to the base 110, with the bead supporter 125 being inserted inside, the spangle S is allowed to fit in between the second surface supporter 123 and the first surface supporter 121. At the time, the bead supporter 125 and the coupling 124 deform toward the center axis AX, and the spangle S is accordingly placed between the second surface supporter 123 and the first surface supporter 121.

When the bead B fitted in the bead supporter 125 is pressed toward the base 110, the bead B is allowed to fit in the bead supporter 125. At the time, the relevant parts are deformed by the slits 126, which widens the opening 127. This may allow the bead B to easily fit in the bead supporter 125.

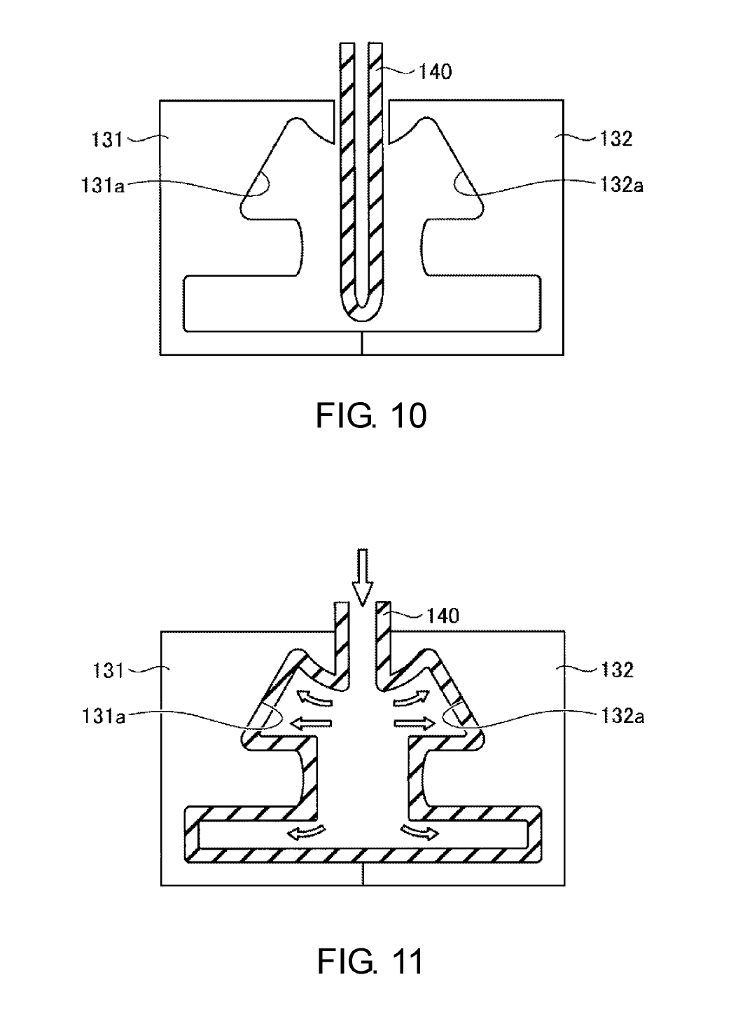

FIG. 10 and FIG. 11 are drawings that illustrate a process to manufacture the decorative member support 200. As illustrated in FIG. 10 and FIG. 11, the decorative member support 200 may be formed by blow molding. First, two dividable outer dies 131 and 132 are prepared, as illustrated in FIG. 10. The outer dies 131 and 132 respectively have inner surfaces 131a and 132a. When the outer dies 131 and 132 are fitted to each other, the inner surfaces 131a and 132a form a shape corresponding to the outer shape of the decorative member support 200. In the illustrated example, a resin 140 dissolved into a bag-like shape is inserted in an inner space formed by the inner surfaces 131a and 132a of the fitted outer dies 131 and 132.

Next, air is blown into the resin 140 so that the resin 140 is swollen, as illustrated in FIG. 11. Then, the resin 140 is pushed against the inner surfaces 131a and 132a of the outer dies 131 and 132. The resin 140 in this state is then cured, and its part used for air injection is removed after being released from the outer dies 131 and 132. As a result, the decorative member support 200 is obtained.

As described so far, the decorative member support 200 according to this embodiment has the base 110 with the adherable part 111 adherable to the fabric, and the supporter 120 that oscillatably supports the decorative member 201 such as spangle S or bead B. The decorative member 201 may be successfully attached to the fabric by adhering the base 110 of the support 200 to the fabric, with the decorative member 201 being supported by the supporter 120 of the support 200. Thus, the decorative member 201 may be readily attached to the fabric without being directly sewn into the fabric. Because the supporter 120 oscillatably supports the decorative member 201, the decorative member 201 may be allowed to oscillate as if it were sewn into the fabric.

When the mark M described in the first embodiment is applied to an attachment position of the base 110 on the fabric, the position of the base 110 on the fabric may be more easily identified. Thus, positioning of the base 110, eventually, positioning of the decorative member, may be less variable.

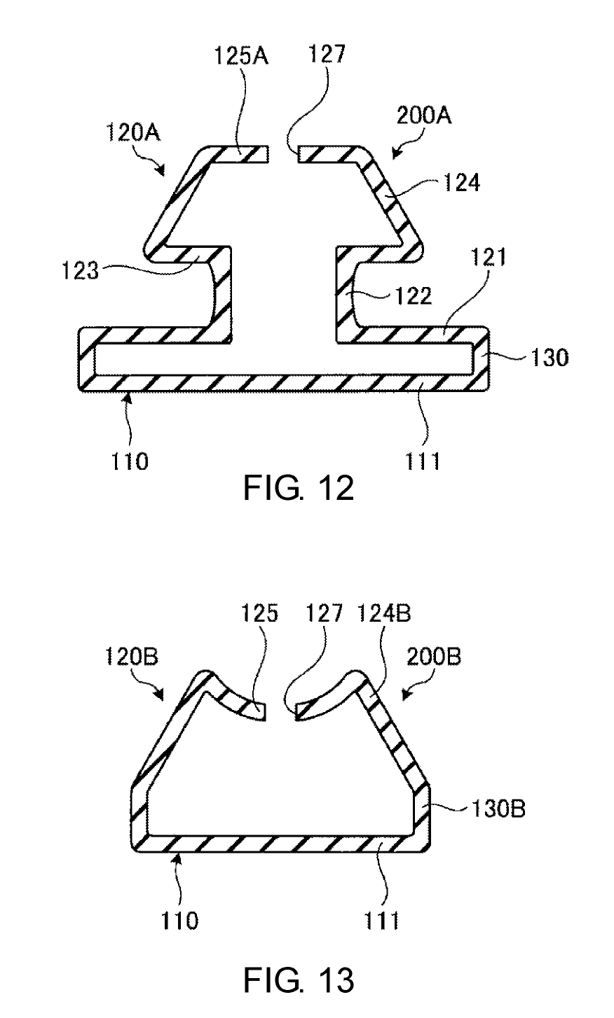

FIG. 12 is a drawing that illustrates a decorative member support 200A according to a modified embodiment of this invention. The decorative member support 200A illustrated in FIG. 12 includes a supporter 120A provided with a planar part 125A, instead of the bead supporter 125. This is a distinct difference to the decorative member support 200. The decorative member support 200A is similar to the decorative member support 200 otherwise.

FIG. 13 is a drawing that illustrates a decorative member support 200B according to a modified embodiment of this invention. The decorative member support 200B illustrated in FIG. 13 is not provided with the supporters that support the spangle S; first surface supporter 121, inner surface supporter 122, and second surface supporter 123. Further, a coupling 130B of the decorative member support 200B is connected to a coupling 124B of a supporter 120B. These are distinct differences to the decorative member support 200. The decorative member support 200B is similar to the decorative member support 200 otherwise.

Thus, the decorative member support is not necessarily structured to support a plurality of different decorative members but may be structured to support one type of decorative member, like the decorative member support 200A illustrated in FIG. 12 or the decorative member support 200B illustrated in FIG. 13.

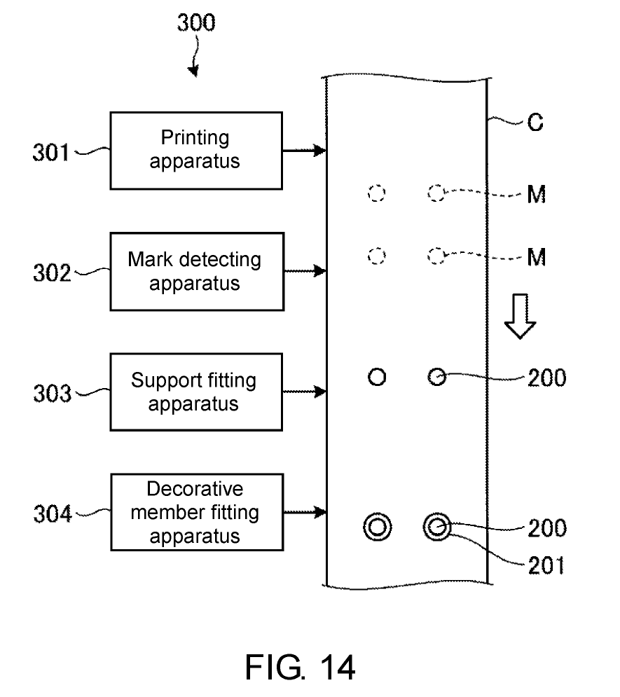

FIG. 14 is a block diagram that illustrates a decorative member fitting system 300 according to a modified embodiment of this invention. The decorative member fitting system 300 is configured to print the mark-applied image on the fabric C and to attach the decorative member 201 to a part including the mark M of the fabric C. As illustrated in FIG. 14, the decorative member fitting system 300 includes a printing apparatus 301, a mark detecting apparatus 302, a support fitting apparatus 303, and a decorative member fitting apparatus 304.

The printing apparatus 301 forms the mark-applied image including the mark M on the fabric C. An example of the printing apparatus 301 may be the printing apparatus 100 described earlier.

The mark detecting apparatus 302 detects the position of the mark M on the fabric C on which the mark-applied image is printed by the printing apparatus 100. The mark detecting apparatus 302 may perform scans on the fabric to detect the mark M, or may capture the image of the fabric C and detect the position of the mark M based on the obtained image. The mark detecting apparatus 302 may be disposed in part of the support fitting apparatus 303 described later.

The decorative member support 200 is fitted to the fabric C by the support fitting apparatus 303. The support fitting apparatus 303 transports the decorative member support 200 towards the mark M on the fabric C and adheres the adherable part 111 to a part including the mark M. The support fitting apparatus 303 may align positions of the decorative member support 200 and the mark M based on the detected result obtained by the mark detecting apparatus 302. Possibly, the fabric C in part is accidentally stretched or corrugated, which may cause a difference between positions of the mark M on the fabric C and the mark M in the second data of the mark-applied image. In such an event, the decorative member support 200 may be very accurately positioned at a part including the mark M of the fabric.

The decorative member fitting apparatus 304 fits the decorative member 201, such as the spangle S or bead B, into the decorative member support 200 on the fabric C. For example, the decorative member fitting apparatus 304 transports the decorative member support 201 to the decorative member support 200 and fits the transported decorative member 201 in the supporter 120. In this instance, the decorative member fitting apparatus 304 may align positions of the decorative member support 200 and the decorative member 201 based on the detected result obtained by the mark detecting apparatus 302. This may allow the decorative member support 200 and the decorative member 201 to be accurately positioned relative to each other.

The decorative member fitting system 300 according to this embodiment is operable to automatically carry out the following two steps in one operational cycle; printing the mark-applied image on the fabric C, and fitting the decorative member 201 in a part including the mark M of the fabric C. As compared with these steps being manually handled, the fabric C with the decorative member 201 successfully attached thereto may be produced with higher efficiency.

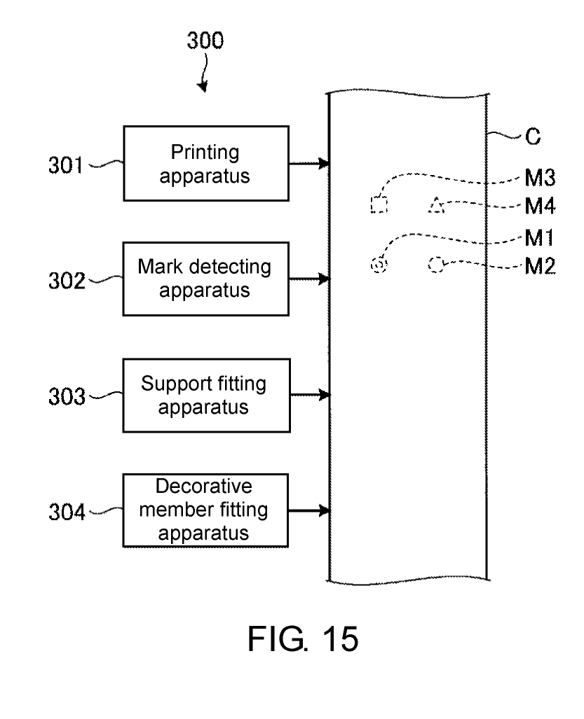

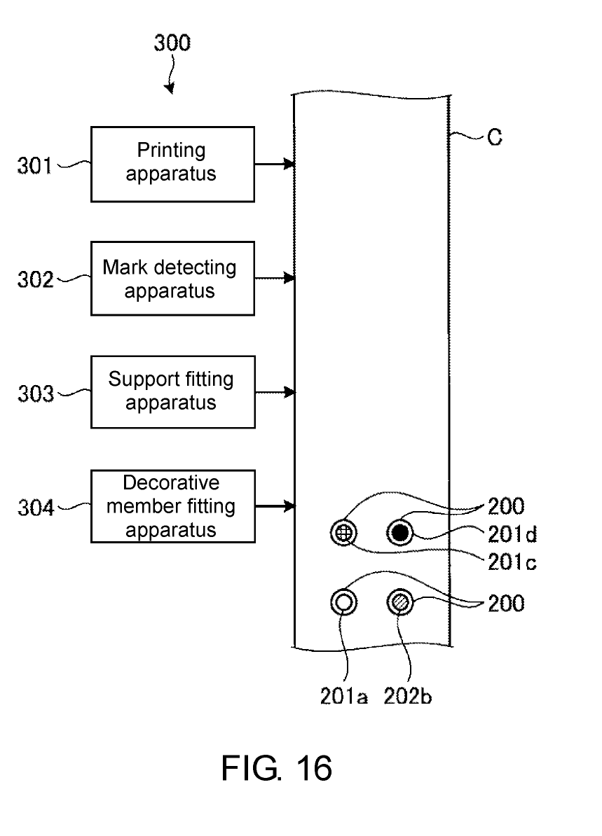

The decorative member fitting system 300 may be configured to selectively use different decorative members 200 depending on the shape, pattern, and/or color of the mark M. FIG. 15 and FIG. 16 are drawings that illustrate exemplified operations of the decorative member fitting system 300. As illustrated in FIG. 15, the printing apparatus 301 may form four different marks M1, M2, M3, and M4 on the fabric C. For example, the mark M1 may be a double circle, the mark M2 may be a single circle, the mark M3 may be a square, and the mark M4 may be a triangle. These marks may have any other suitable shapes. In this instance, the mark detecting apparatus 302 may be configured to detect the marks M1, M2, M3, and M4 by identifying their types or shapes in addition to their positions. Then, the decorative member support 200 is fitted by the support mounting apparatus 303 in parts including the marks M1, M2, M3, and M4 on the fabric C.

Then, a suitable one of the different decorative members for the mark M1, M2, M3, or M4 is selected and fitted in the decorative member support 200 by the decorative member fitting apparatus 304. For example, the decorative member fitting apparatus 304 may use a gold decorative member 201a at a position at which the mark M1 is formed, a silver decorative member 201b at a position at which the mark M2 is formed, a bronze-colored decorative member 201c at a position at which the mark M3 is formed, and a black decorative member 201d at a position at which the mark M4 is formed. The decorative members 201a to 201d may include but are not limited to such differently colored decorative members. The decorative members 201a to 201d may be selected from differently shaped decorative members, or may be selected from different types of decorative members, for example, some of them are beads and the others are spangles. Thus, the decorative member fitting system 300 may form different marks on the fabric C and selectively use a suitable one of decorative members that differ in color, shape, pattern, or type for each of the marks. In this instance, marks and decorative members used correspondingly to the marks may be decided beforehand, or may be decided when the marks are formed.

The technical scope of this invention is not limited to the embodiments described thus far and may be variously modified to an extent such modifications stay within the spirit and scope of this invention. It is described in the embodiments that the predetermined condition to be set at the time of deciding the target position of the decorative member includes at least one of the shape, size, quantity, and pitch of the mark to be applied to the target position. The predetermined condition, however, is not necessarily limited to such elements of the mark.

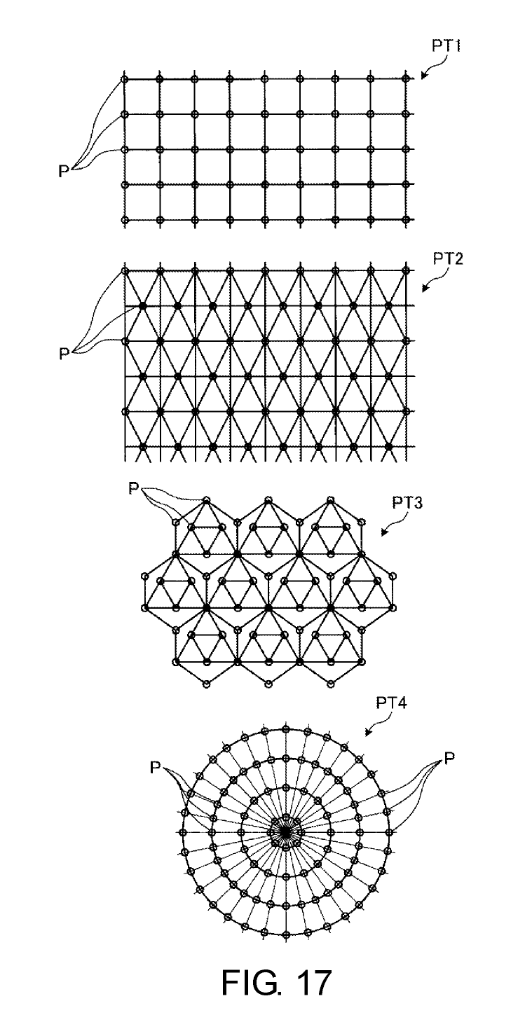

FIG. 17 is a drawing that illustrates examples of arrangement of target positions. The predetermined condition may be one selected from preset patterns of target positions P illustrated in FIG. 17. In a pattern PT1 illustrated in FIG. 17, the target positions P are arranged at points of intersection on a lattice pattern. In a pattern PT2 illustrated in FIG. 17, target positions P are arranged at positions laterally displaced from by a half pitch from adjacent positions on longitudinally parallel lines of the lattice pattern. A pattern PT3 illustrated in FIG. 17 is a geometrical pattern consisting of small patterns each formed by, for example, a regular hexagon, a regular triangle including three apexes of the regular hexagon, and another regular triangle whose apexes are medians on three sides of the regular triangle. In this geometrical pattern, the target positions P are arranged at the respective apexes. In a pattern PT4 illustrated in FIG. 17, target positions P are arranged on circumferences of concentric circles that differ in diameter. The target positions P are not necessarily arranged as illustrated in FIG. 17 and may be arranged otherwise.

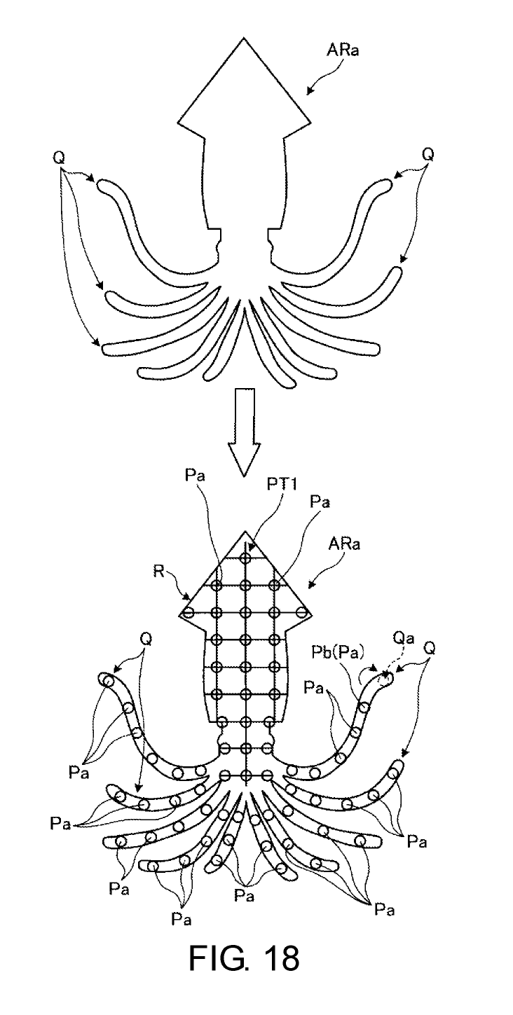

FIG. 18 is a drawing that illustrates an example in which the target positions are decided and set by the target position setting unit 64. Referring to FIG. 18 is described an example in which a target region ARa is defined that includes a region Q and a region R larger than the region Q. The region Q is a band-like or linear region extending along a straight line or a curved line direction. When the target region ARa including the regions Q and R is defined, the target position setting unit 64 detects shapes and sizes of different parts of the target region ARa and determines whether each part is included in the region Q or the region R. The position setting unit 64, after determining whether the parts are included in the region Q or the region R, may set target positions Pa on a line along a direction in which the region Q extends. In this instance, the target position setting unit 64 may detect the region Q-extending direction and dimension of the region Q along its width (direction orthogonal to the region Q-extending direction) and then decide the number and pitch of the target positions Pa based on the detected result. The region Q may have an island-like shape. In this instance, the target position setting unit 64 may set the target positions Pa on dots in the region Q. In the region R, for example, the target positions P may be arranged as illustrated in the patterns PT1 to PT4 (see FIG. 17) or in any other suitable patterns. The target position setting unit 64 may detect the shape and dimension of the region R and select a pattern suitable for the detected result. In the example of FIG. 18, the target positions P are arranged according to the pattern PT1 illustrated in FIG. 17, however, the target positions P may be arranged as illustrated in the other patterns. The region R may include different patterns in different parts or may include one or more of the patterns PT1 to PT4 enlarged or reduced in size. The operator may manually change the target positions Pa decided and set in the regions Q and R by the target position setting unit 64. FIG. 18 illustrates an example in which a target position Pb, among the target positions Pa, has been moved to an edge position Qa of the region Q. The target positions Pa may be arranged as desired by thus allowing the operator to manually change the target positions Pa set by the target position setting unit 64.

### REFERENCE SIGNS LIST

10 Fabric transporter
20 Image formation device
30 Fabric supporter
40 Display device
50 Operation device
60 Control device
61 Generator
62 Display controller
63 Image formation controller
64 Target position setting unit
65 Mark setting unit
66 Image combining unit
100, 301 Printing apparatus
110 Base
111 Adherable part
120 Supporter
121 First surface supporter
122 Inner surface supporter
123 Second surface supporter
124,130 Coupling
125 Bead supporter
126 Slit
127 Opening
131,132 Outer die
131a, 132a Inner surface
140 Resin
200, 200A, 200B Decorative member support
201 Decorative member
300 Decorative member fitting system
302 Mark detecting apparatus
303 Support fitting apparatus
304 Decorative member fitting apparatus
C Fabric
D1 Original image
D2 Mark-applied image
M Mark
B Bead
S Spangle
P, P1-P9, Pa, Pb Target position
Q, R Region
Qa Edge position
AR, ARa Target region
AX Center axis

1. A printing apparatus, comprising:
an image formation device, configured to eject an ink for image formation to a fabric to form an image on the fabric; and
a control device, configured to generate, based on a first image data of an original image to be formed on the fabric, a second image data of a mark-applied image which is the original image additionally including a mark at a target position of a decorative member to be attached to the fabric, and the control device is further configured to control the image formation device based on the second image data so as to form the mark-applied image on the fabric.

2. The printing apparatus as set forth in claim 1, wherein,
when a target region of the decorative member is defined in at least part of the original image, the control device is configured to decide, as the target position, a position in the target region meeting a predetermined condition.

3. The printing apparatus as set forth in claim 2, wherein
the predetermined condition includes at least one of a shape, a size, a quantity, a pitch, and a pattern of the mark to be applied to the target position.

4. The printing apparatus as set forth in claim 1, wherein
the control device is configured to set the mark to be displayed in a color that differs from a color used in a part surrounding the target position in the original image.

5. The printing apparatus as set forth in claim 1, further comprising:
a display device, configured to be capable of displaying the mark-applied image.

6. The printing apparatus as set forth in claim 5, further comprising:
an operation device, configured to be capable of changing the target position in the original image.

7. A printing method for being utilized in a printing apparatus including an image formation device that ejects an ink for image formation to a fabric to form an image on the fabric, and the printing method comprising:
a generating step of generating, based on a first image data of an original image to be formed on the fabric, a second image data of a mark-applied image which is the original image additionally including a mark at a target position of a decorative member to be attached to the fabric; and
an image forming step of forming the mark-applied image on the fabric based on the second image data using the image formation device.

8. A decorative member support that supports a decorative member attached to a fabric, and the decorative member support comprising:
a base, having an adherable part adherable to the fabric; and
a supporter, integral with the base and serving to support the decorative member.

9. The decorative member support as set forth in claim 8, wherein
the decorative member has an annular shape, and
the supporter oscillatably supports the decorative member.

10. The decorative member support as set forth in claim 9, wherein the supporter comprises:
a first surface supporter that supports a first surface of the decorative member on a side thereof closer to the fabric;
a second surface supporter that supports a second surface of the decorative member on a side thereof opposite to the fabric; and
an inner surface supporter that supports an inner surface of the decorative member,
wherein the first surface supporter and the second surface supporter having diameters greater than an inner diameter of the decorative member,
the inner surface supporter having a diameter smaller than the inner diameter of the decorative member,
the first surface supporter and the second surface supporter being spaced apart with a distance greater than a thickness of the decorative member.
